(19) United States
(12) Patent Application Publication
(10) Pub. No.: US 2010/0193975 A1
(43) Pub. Date: Aug. 5, 2010

(54) HUMIDIFIER

(75) Inventors: Andreas Kammann, Heidelberg (DE); Udo Eping, Darmstadt (DE); Bernd Altmueller, Birkenau (DE)

Correspondence Address: DARBY & DARBY P.C., P.O. BOX 770, Church Street Station, New York, NY, 10008-0770, US

(73) Assignee: CARL FREUDENBERG KG, Weinheim (DE)

(21) Appl. No.: 12/677,399

(22) PCT Filed: Aug. 29, 2008
(86) PCT No.: PCT/EP08/07068

§ 371 Date: Mar. 10, 2010

(30) Foreign Application Priority Data
Sep. 12, 2007 (DE) 10 2007 043 330.3

(51) Int. Cl. B01F 3/04

(52) U.S. Cl. 261/75

(57) ABSTRACT

A humidifier includes a housing and a humidifier module having a first and a second end face and a plurality of replacement members secured at the first and second end faces by a sealing compound, wherein the housing is configured to accommodate the humidifier module, and wherein the humidifier module is retained in the housing in positive engagement with the housing at at least one of the first and the second end face.

This application is a U.S. National Phase Application under 35 U.S.C. §371 of International Application No. PCT/EP2008/007068, filed on Aug. 29, 2008, which claims benefit to German Application No. DE 10 2007 043 330.3, filed on Sep. 12, 2007. The International Application was published in German on Mar. 26, 2009 as WO 2009/036872 under PCT Article 21 (2).

The present invention relates to a humidifier, including a housing for accommodating a humidifier module, the humidifier module encompassing replacement members which are set in place at both end faces by a sealing compound.

### BACKGROUND OF THE INVENTION

Humidifiers of this kind are known from the World Patent Application WO 2007/020107 A1 and are used in fuel cells, in particular in PEM fuel cells. These fuel cells require humidified air for the operation thereof, in order to prevent the fuel cell membrane from drying out. The humidifier housing has a basic round or rectangular shape, and it is sealed at each of the two end faces by a lid. Configured within the housing are replacements members, which are frequently hollow fibers. The boundary surfaces of the replacement members are circumflowed from one side by humid air and, from the other side, by air that is to be humidified, and an exchange of materials takes place through the replacement members. An effective exchange of materials requires that there be no direct contact of the two air flows and no contact with the ambient air. To this end, seals that seal off the air flows from one another and from the ambient environment, are configured in the housing. When sealing the humidifier, it is problematic that the housing and the humidifier module have different thermal expansion coefficients and that the humidifier module is sensitive to mechanical stress.

### SUMMARY OF THE INVENTION

An aspect of the present invention is to further refine the humidifier in a way that will improve the integration of the humidifier module in the housing.

To achieve the objective, the humidifier module is retained in the housing in positive engagement therewith at at least one end face. The humidifier module is securely held in position by the form-locking connection thereof within the housing, the connection being able to be implemented in such a way that the humidifier module is fixed in place in a radially and axially stress-free manner. The sealing is accomplished by an additional sealing element that sealingly surrounds the humidifier module radially and axially in a flexible manner and thereby reliably separates the mass flows from one another and from the ambient environment. In this context, the seal is designed to provide reliable sealing action in the presence of pressure differentials of up to 1.5 bar that occur between the mass flows and in the presence of pressure differentials of up to 5 bar relative to the ambient environment. The replacement members are preferably made of hollow fibers which are configured as bundles in the housing and are joined to one another at both end faces by a sealing compound. The sealing compound seals the interstitial spaces among the fibers, so that an air flow entering via the end face of the replacement members is only able to flow through the hollow fibers. The sealing compound is preferably made of a synthetic resin, for example an epoxy resin. To manufacture the humidifier, the hollow fibers are placed in the housing and are then connected directly within the housing. This permits adaptation of the humidifier module to any housing form. To effect the form-locking engagement, indentations, undercuts or raised portions are formed in the housing. They are filled with or surrounded by the sealing compound. Therefore, the form-locking engagement may be readily effected, and the humidifier module is held securely in position in the housing. Due to the manufacturing-induced contraction and the different thermal expansion coefficients, a gap remains between the housing and the humidifier module that is sealed by the seal. At the same time, the gap provides a clearance that allows the humidifier module to be supported in a stress-free manner.

The humidifier module may be retained in the housing in positive engagement therewith at both end faces. In this context, indentations, undercuts or raised portions are provided on the inner periphery of the housing in the area of both end faces. They must be configured in such a way that the humidifier module is, in fact, fixed in position and centrosymmetrical in all spatial directions, but that also permits a stress-free compensation of temperature- or manufacturing-induced expansion or contraction. In the case of the form-locking fixing in position on both sides, it is advantageous that the seals which are configured at both end faces do not have any static load to support, permitting optimization thereof for optimal seal tightness.

At the inner peripheral surfaces, the housing may feature recesses into which the sealing compound of the humidifier module extends. The recesses may be readily produced, and they do not reduce the effective cross section of the housing.

The housing is preferably flat in form, each of the recesses at the wide, inner peripheral surfaces being formable by a peripherally extending groove and, at the narrow, inner peripheral surfaces, by a centrally configured indentation. Flat is understood here to mean a housing having a rectangular or flat oval form. A humidifier having a rectangular or flat oval form permits a space-saving installation. Due to the groove configured at the broad sides and the indentation configured at the narrow sides, the humidifier module is centrally supported within the housing.

The grooves may each be interrupted by a centrally disposed ridge. The ridge functions as a limit stop and limits the free play of the humidifier module. The ridge also reduces the effective length that is available to the sealing compound during contraction. Accordingly, the play is diminished by the ridge upon hardening of the sealing compound.

The inner peripheral surfaces may be provided with a coating. The coating prevents a substance-to-substance bonding of the sealing compound to the housing during manufacturing. For this purpose, the coating may contain PTFE, for example.

The sealing compound may project beyond the end faces of the housing. This permits a simple sealing of the humidifier module and at the same time allows axial freedom of movement thereof. The seal may sealingly surround the projecting peripheral surface of the humidifier module and also slide thereon.

Both end faces of the housing may be sealed by a lid; and a flat seal may be located in each case between the housing and the lid. Inlet and outlet ports for the two air flows are integrated in the lids. On the one hand, the flat seal seals off the two air flows from the ambient environment and, on the other hand, it also fits on the humidifier module, so that it also separates the two air flows from one another.

The flat seal may feature a peripheral sealing lip that sealingly surrounds the humidifier module. The sealing lip rests against the peripheral surface of the humidifier module under radial pretensioning and permits an axial movement of the humidifier module. Depending on the length of the sealing lip, a radial movement of the humidifier module is also possible. This makes it possible to compensate for any clearance variation caused by different temperature expansion coefficients.

The flat seal may be retained in the housing in positive engagement therewith. This facilitates positioning of the flat seal on the housing and simplifies the installation.

The flat seal may have at least one peripherally extending raised portion at both end faces. The raised portions locally enhance the contact pressure and improve the sealing action.

### BRIEF DESCRIPTION OF THE DRAWINGS

A few exemplary embodiments of the humidifier according to the present invention are clarified in the following with reference to the figures. They show schematically:

FIG. 1: a humidifier in a longitudinal section;

FIG. 2: in detail, an end face of the housing in a perspective view.

### DETAILED DESCRIPTION

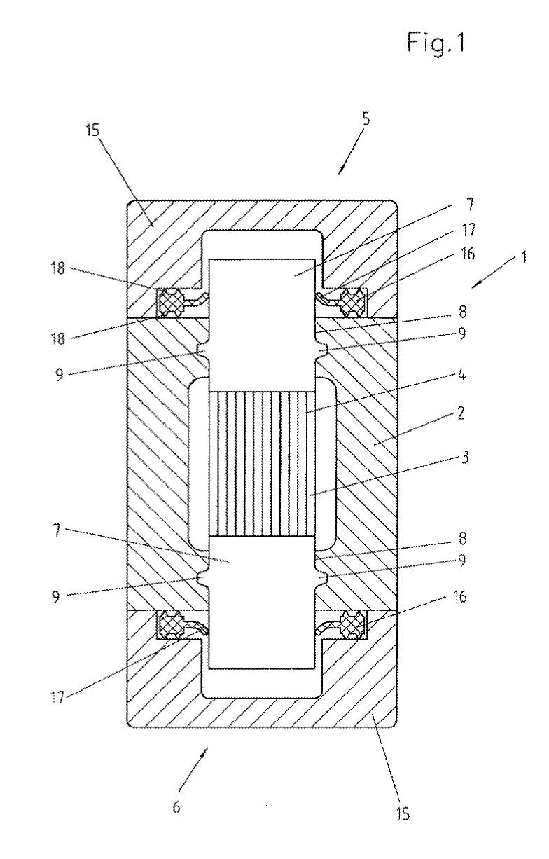

FIG. 1 shows a humidifier 1 which has a housing 2 having a rectangular cross section. Located within housing 2 is a humidifier module 3. The humidifier module is composed of a multiplicity of replacement members 4 that are formed from hollow fibers. Replacement members 4 are fixed in position at both end faces 5, 6 by a sealing compound 7 made of synthetic resin, so that the interstitial spaces among replacement members 4 are filled. At both end faces 5, 6, housing 2 has recesses 9 on inner peripheral surfaces 8. Sealing compound 7 extends into these recesses 9 and thereby fixes humidifier module 3 in position within housing 2 in positive engagement therewith on both sides. Inner peripheral surfaces 8 having recesses 9 are provided with a coating in order to prevent a substance-to-substance bonding between housing 2 and humidifier module 3. Humidifier module 3 has a greater axial extent than housing 2, so that the sealing compound projects beyond end faces 5, 6 of housing 2. The two end faces 5, 6 of housing 2 are each sealed by a lid 15, a flat seal 16 being located in each case between housing 2 and lid 15. To provide improved stability, this flat seal 16 is an elastomer-metal composite component. Flat seal 16 has a peripheral sealing lip 17 that fits sealingly on the outer periphery of sealing compound 7 of humidifier module 3 under radial pretensioning, surrounding the same. In addition, flat seal 16 is provided at each of the two end faces with two peripherally extending raised portions 18.

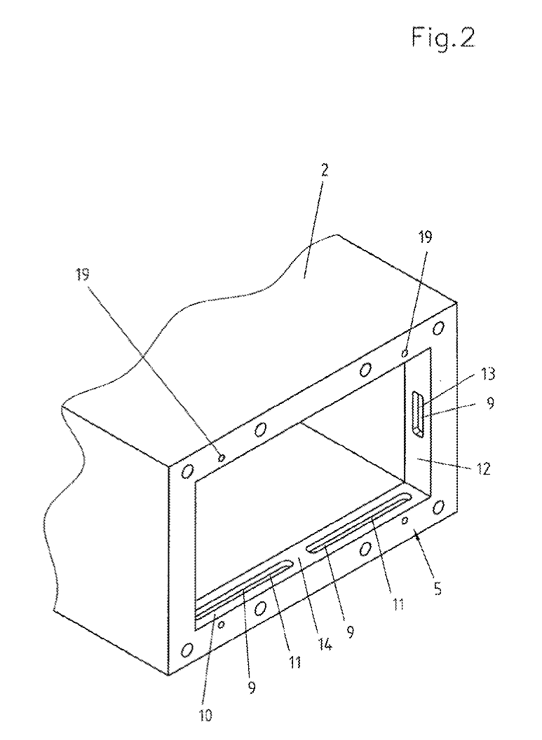

FIG. 2 shows in detail housing 2 of a humidifier in accordance with FIG. 1 in a perspective view. In accordance with FIG. 2, housing 2 has a flat, rectangular form. At the two wide, inner peripheral surfaces 10, recesses 9 are each formed by a peripherally extending groove 11 and, at the two narrow, inner peripheral surfaces 12, in each case by a centrally configured indentation 13. Grooves 11 are each interrupted by a centrally disposed ridge 14. Bores 19 are introduced at end faces 5, 6 of housing 2. Through these bores 19, pins are inserted that are adapted for holding flat seal 16 in housing 2 in positive engagement therewith.

1-11. (canceled)

12. A humidifier comprising:
a housing; and
a humidifier module having a first and a second end face and a plurality of replacement members secured at the first and second end faces by a sealing compound, wherein the housing is configured to accommodate the humidifier module, and wherein the humidifier module is retained in the housing in positive engagement with the housing at at least one of the first and the second end face.

13. The humidifier as recited in claim 12, wherein the humidifier housing is positively engaged with the housing at the first and second end faces.

14. The humidifier as recited in claim 12, wherein the housing includes a plurality of recesses into which the sealing compound extends.

15. The humidifier as recited in claim 14, wherein the housing has a flat form with a wide and a narrow inner peripheral surface, and wherein at least one peripherally extending groove forms at least one of the plurality of recesses disposed at the wide surface and at least one centrally configured indentation forms at least one of the plurality of recesses disposed at the narrow surface.

16. The humidifier as recited in claim 15, wherein the at least one peripherally extending groove is interrupted by a centrally disposed ridge.

17. The humidifier as recited in claim 15, wherein a coating is disposed on the wide surface.

18. The humidifier as recited in claim 12, wherein the sealing compound projects beyond the first and second end faces.

19. The humidifier as recited in claim 12, further comprising a first lid sealing the first end face, a second lid sealing the second end face and a flat seal disposed between the housing and each one of the first and second lids.

20. The humidifier as recited in claim 19, wherein the flat seal includes a peripheral sealing lip sealingly surrounding the humidifier module.

21. The humidifier as recited in claim 19, wherein the flat seal is retained in the housing in positive engagement with the housing.

22. The humidifier as recited in claim 19, wherein the flat seal includes at least one peripherally extending raised portion disposed at the first and second end faces.
